(19) United States
(12) Patent Application Publication
(10) Pub. No.: US 2012/0205879 A1
(43) Pub. Date: Aug. 16, 2012

(54) DRILL CHUCK

(76) Inventor: Hans-Dieter MACK, Sontheim (DE)

(21) Appl. No.: 13/354,457

(22) Filed: Jan. 20, 2012

(30) Foreign Application Priority Data
Feb. 10, 2011 (DE) 102011000611.7

(51) Int. Cl. B23B 31/16

(52) U.S. Cl. 279/60

(57) ABSTRACT

A chuck has a body rotatable about a body axis and having an axially forwardly open central threaded hole and a tightening assembly rotatable about the axis on the chuck body and formed with a plurality of angularly spaced guides each having a face extending at an angle substantially greater than 20° to the body axis. Respective jaws are shiftable along the guide faces between radial outer positions and radial inner positions. A pusher angularly coupled to the jaws and to the tightening assembly is threaded into the hole of the body such that rotation of the assembly on the body in a tightening direction screws the pusher axially forwardly in the chuck body and shifts the jaws axially forward and radially inward on the respective guide faces and opposite rotation in a loosening direction shifts the jaws axially rearward and radially outward on the respective guide faces.

### FIELD OF THE INVENTION

The present invention relates to a drill chuck.

### BACKGROUND OF THE INVENTION

A standard drill chuck has a chuck body centered on and rotatable by a drive spindle about a body axis and having an axially forwardly open central threaded hole and a tightening assembly typically formed by a sleeve and holder, rotatable about the axis on the chuck body, and formed with a plurality of angularly spaced guides each having a face extending at an acute angle to the body axis. Respective jaws are shiftable along the guide faces between radial outer positions retracted axially rearwardly into the tightening assembly and radial inner positions projecting axially forwardly from the tightening assembly. A pusher angularly coupled to the jaws and to the tightening assembly is threaded into the hole of the body such that rotation of the assembly on the body in a tightening direction screws the pusher axially forwardly in the chuck body and shifts the jaws axially forward and radially inward on the respective guide faces and opposite rotation in a loosening direction shifts the jaws axially rearward and radially outward on the respective guide faces.

Such a drill chuck is known, for example from U.S. Pat. No. 7,845,650, whereby this flat jaw drill chuck has specially formed clamping jaws that ensure safe clamping of tools extending over the entire life cycle of the drill chuck.

Electrically operated hand drills or power screwdrivers whether battery- or line-powered are generally L-shaped with one leg provided on its end with the chuck and the other leg serving as a handle. Because the drill chuck is located at the end of the one leg, a continuous turning moment effective on the machine must be compensated for by the user. This turning moment can be reduced by axial shortening and by weight reduction of the drill chuck, which thus represents a significant improvement for this type of top-heavy machine.

In addition to the decrease of the turning moment that is effective on the machine during its use, shorter construction of the drill chuck further offers a financial advantage during its production. If the drill chuck is shorter and lighter, fewer materials are used and correspondingly, material costs are lower.

It has been standard practice for many years to prefer an angle of the guide relative to the drill chuck of 20°. Accordingly, even in the known drill chuck, this standard is used. As a result the drill chuck cannot be short.

### OBJECTS OF THE INVENTION

It is therefore an object of the present invention to provide an improved drill chuck.

Another object is the provision of such an improved drill chuck that overcomes the above-given disadvantages, in particular that has a compact structure with shortened axial length and as a result reduced weight.

### SUMMARY OF THE INVENTION

A chuck has according to the invention a chuck body centered on and rotatable by a drive spindle about a body axis and having an axially forwardly open central threaded hole and a tightening assembly rotatable about the axis on the chuck body and formed with a plurality of angularly spaced guides each having a face extending at an angle substantially greater than 20° to the body axis. Respective jaws are shiftable along the guide faces between radial outer positions retracted axially rearwardly into the tightening assembly and radial inner positions projecting axially forwardly from the tightening assembly. A pusher angularly coupled to the jaws and to the tightening assembly is threaded into the hole of the body such that rotation of the assembly on the body in a tightening direction screws the pusher axially forwardly in the chuck body and shifts the jaws axially forward and radially inward on the respective guide faces and opposite rotation in a loosening direction shifts the jaws axially rearward and radially outward on the respective guide faces.

Thus according to the invention the intersection of the guide axes defined by the faces of the tightening-assembly guides are, in contrast to a standard drill chuck, offset rearward toward the tool seat.

This has the advantage that the drill chuck has a compact structure and is thereby reduced in length and in weight, as a result of which the user need only compensate for a smaller torque impinging on the drilling machine due to the drill chuck.

A further advantage is that the angle of the guide axes to the chuck axis is between 20° and 50°. In the case of an angle greater than 50°, the gripping force would be drastically reduced, as a result of which safe gripping of drilling tools would no longer be ensured.

For this reason, it is further advantageous if the angle of the guide axes relative to the chuck axis is between 25° and 35°. This range establishes an optimal relationship between the gripping force and the length of the drill chuck.

An advantageous embodiment is that the pusher screwthread and the chuck-body screwthread are designed with a reduced thread pitch in contrast to a standard drill chuck. This prevents loss of gripping force due to the shortness of the drill chuck. If the pitch angle of the threads is reduced, and if the force with which the threads are tightened remains the same, a greater gripping force consequently results. Moreover, a stronger axial retention is established, as now more turns of a thread engage with each other extending over the axial engagement section that remains constant.

Moreover, it is advantageous when the pusher screwthread and/or the chuck-body screwthread are axially extended. The axial forces impinging on a drill chuck during the drilling process are compensated by the how much of the pusher screwthread engages with the chuck-body screwthread. Due to the elongation of the two engaging screwthreads, the stronger forces in a short drill chuck are compensated for better. For this reason, with the help of abutments, a minimum engagement section is specified by the screwthreads in the gripping thread.

Moreover, it is advantageous when the tightening cone is designed with cone walls that become thicker axially forward toward the opening of the tool seat. This shape of the tightening cone ensures that the increasingly impinging radial load on the gripping jaws and thus on the tightening cone is advantageously compensated for in a short drill chuck.

It is also advantageous when the inner jaw faces are parallel to the chuck axis. Thus drill tools that are to be clamped in the tool seat can be secured with the largest possible friction fit. As a result of the special design of the gripping jaws, as they are disclosed in the publication cited above, further possibilities are given for forming locking tool seats by means of frictional fit and/or positive fit of the drill tool.

A further advantageous embodiment is that the connection for a machine tool to a spindle connection is a spindle hole for receiving a tool spindle. In this way, the weight of the drill chuck can be reduced, as less material is required for its production.

It is also advantageous if the connection for a machine tool is formed by a tool spindle that is unitarily formed with the chuck body. As a result, the drill chuck and the tool spindle can be produced in one machining step. Moreover, there is no longer a joint between the drill chuck and the tool spindle, which increases the stability of the drill chuck.

### BRIEF DESCRIPTION OF THE DRAWING

The above and other objects, features, and advantages will become more readily apparent from the following description, reference being made to the accompanying drawing in which:

FIG. 1 is a short self-tightening drill chuck partly in longitudinal section, partly in side view; and

FIGS. 2 and 3 are similar partly sectional views of short self-tightening drill chucks according to the invention;

FIG. 4 is another partly sectional view of a chuck with an integral drive spindle;

FIGS. 5 and 6 are similar partly sectional views of two further short self-tightening drill chucks according to the invention; and

FIG. 7 is a partly sectional view of a further drill chuck in accordance with the invention with an integral drive spindle.

### DETAILED DESCRIPTION

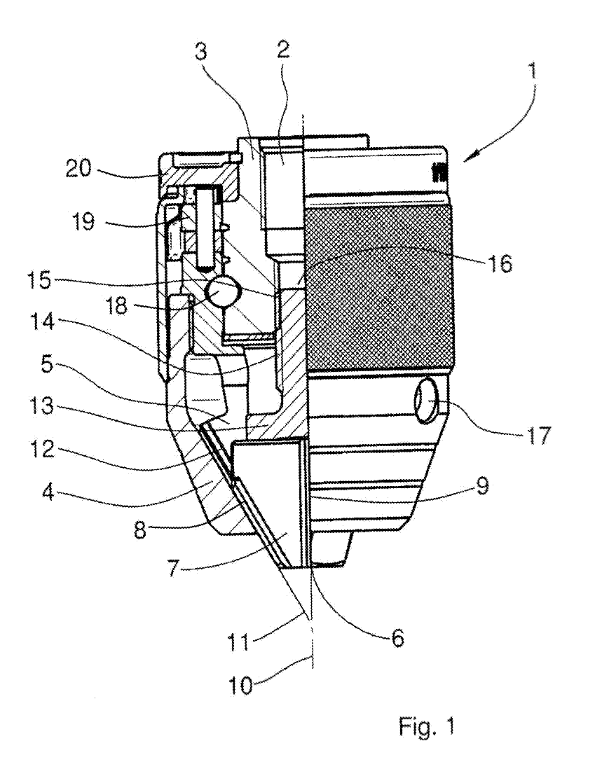

As seen in FIG. 1 a chuck 1 according to the invention has a chuck body 3 centered on an axis 10 and formed with a rearwardly open threaded bore 2 forming a drive-spindle connector and a forwardly open bore 16 of slightly smaller diameter formed with an internal screwthread 15. A clamping assembly is formed by a two-part sleeve 4 that is axially fixed but rotatable on the body 3 via a ball bearing 18 and that is rotationally coupled to a holder 5. Angularly equispaced guides 12 in the holder 5 hold respective gripping jaws 7 each having an outer edge 8 lying on a frustoconical inner surface of the sleeve 4 and therefore extending along an axis 11 that intersects the axis 10 and an inner edge 9 that extends parallel to the axis 10. These jaws 7 in turn ride in respective radially extending and forwardly open grooves of a central pusher 13 having a stem 5 formed with an external screwthread 14 meshing with the internal screwthread 15 of the forwardly open bore 16 of the chuck body 3.

Thus the jaws 7, as is standard, can define a tool-holding seat 6. Rotation of the assembly 4, 5 in a tightening direction about the axis 10 moves the jaws 7 radially inward and axially forward (down in FIG. 1) to grip a tool or workpiece in the seat 6, and opposite rotation in a loosening direction moves the jaws radially outward and axially rearward to release the tool or workpiece.

Further, the chuck 1 has a locking mechanism that is coaxial to a chuck axis 10. It consists of a pawl 19 pivotal on the tightening assembly about an axis parallel to the axis 10 and having two arms, one of which engages a ring of gear teeth formed on the chuck body 3 coaxial to the chuck axis 10 and the other of which is biased by an unillustrated compression spring that pivots the pawl 10 around its axis to engage the one arm with the gear teeth. The locking mechanism is designed in such a way that upon engagement of the pawl 19 with the ring of gear teeth, rotation of the chuck body 3 relative to the tightening sleeve 4 in the loosening direction is blocked to prevent disengagement of the gripping jaws 7. Relative rotation in an opposite tightening direction is unimpeded by the locking mechanism, as the pawl 19 can slide or ratchet over the gear teeth, which may be of sawtooth shape.

A release ring 20 coaxial to the chuck axis 10 and to tightening sleeve 4, in the embodiment in FIG. 1, can be rotated between a locked position in which the one pawl arm only allows the chuck to be tightened and an unlocked position in which a cam edge on the ring 20 engages the other arm of the pawl 19 and lifts the one arm out of engagement with the teeth so the sleeve 4 can be rotated to loosen the chuck.

The intersection of the guide axes 11 is offset toward the tool seat 6 as compared with a standard drill chuck. In contrast, in the shown embodiment, the angle of the guide axes 11 is 30° relative to the chuck axis 10.

In view of the considerable forces exerted on it, the illustrated tightening sleeve 4 is made of an increasing wall thickness axially forward along the guide axes 11 and toward the front end of the chuck 1 where the tool seat 6 opens.

In this embodiment, the guide slots 12, the pusher screwthread 14 and the chuck-body screwthread 15 are made as long as possible in order to ensure that in a short drill chuck 1, the stronger axial forces are advantageously compensated for. Furthermore, the tightening sleeve 4 is formed with a bore 17 through which when being used overhead it ejects any dust that gets into the drill chuck 1 during drilling or screwing.

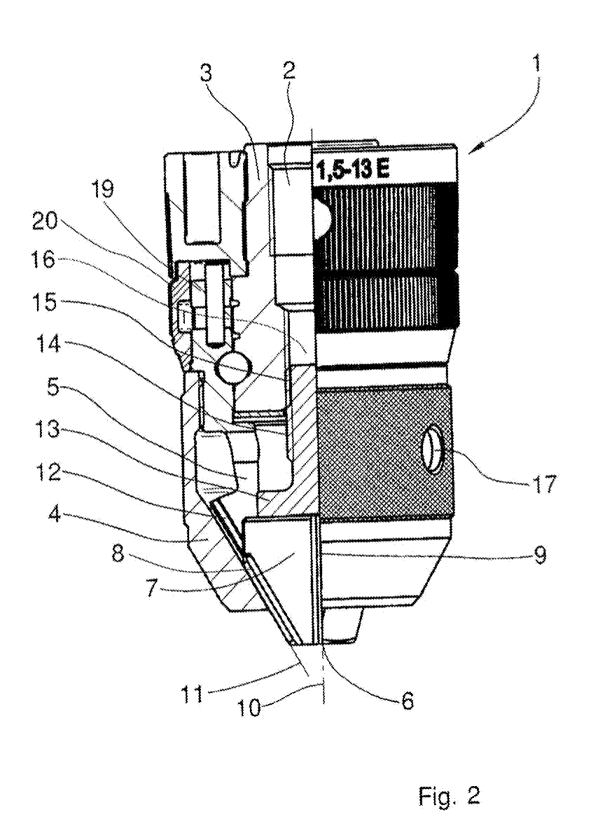

FIG. 2 shows an embodiment of the drill chuck 1 different from that of FIG. 1. The release ring shown here is actuatable from the tightening sleeve 4. Thus, first the pawl 19 can be disengaged from the ring of gear teeth with the help of the inner cam edge of the release ring 20, as a result of which loosening or unlocking of the drill chuck 1 is possible. This way the tightening sleeve 4 can be actuated in order to spread the tool seat 6.

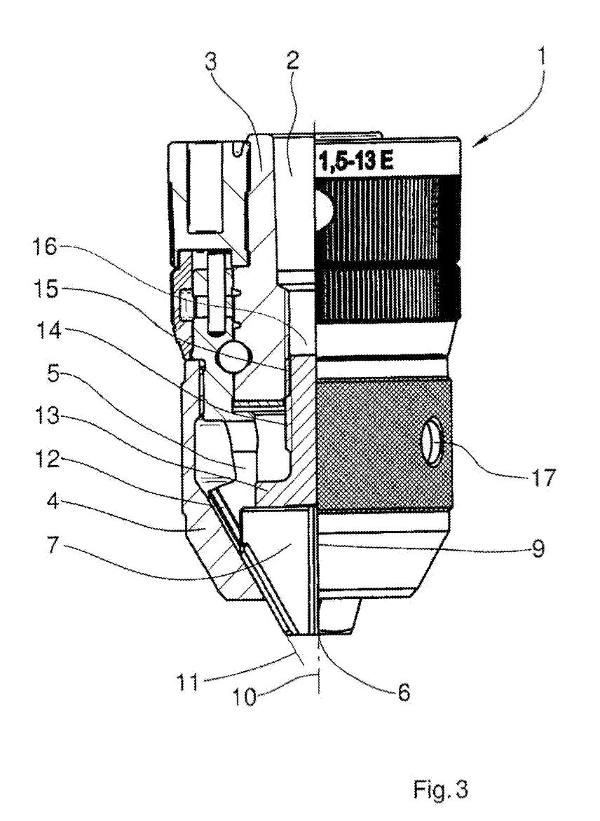

An embodiment of the chuck different from FIG. 2 is shown in FIG. 3, where the spindle connection is not formed with an internal screwthread. The spindle connection is a smooth surface bore 2 frustoconically tapered toward the tool seat 6 to make a friction fit between the spindle connection 2 and a drive spindle possible.

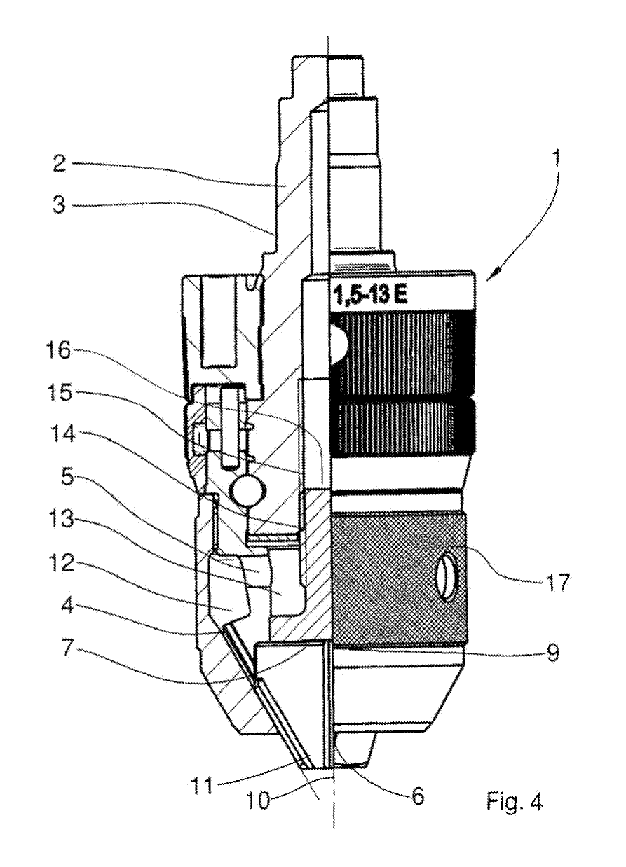

In FIG. 4, an embodiment of the drill chuck different from FIGS. 1-3 is shown where the connection for a machine tool is formed by a tool spindle 2 that is integrally formed with the chuck body 3.

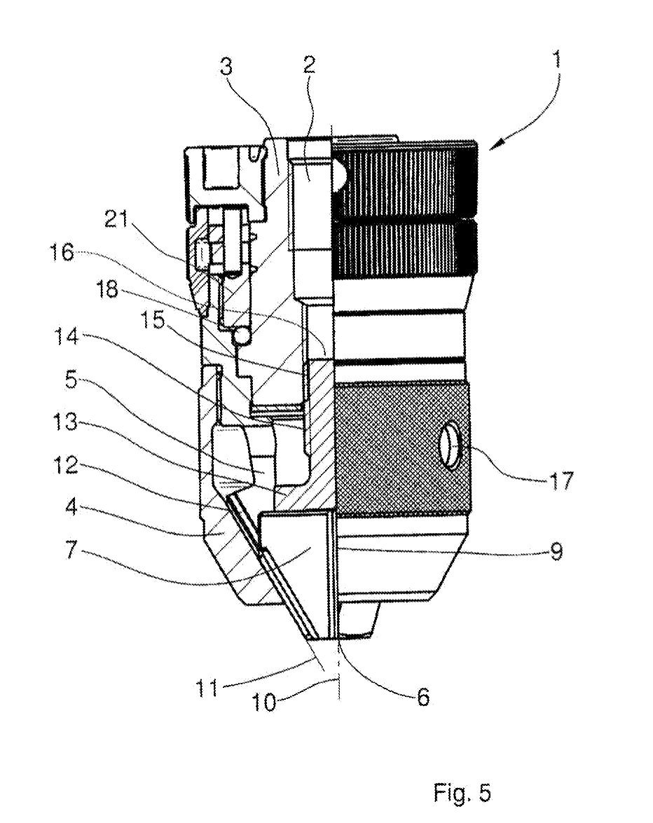

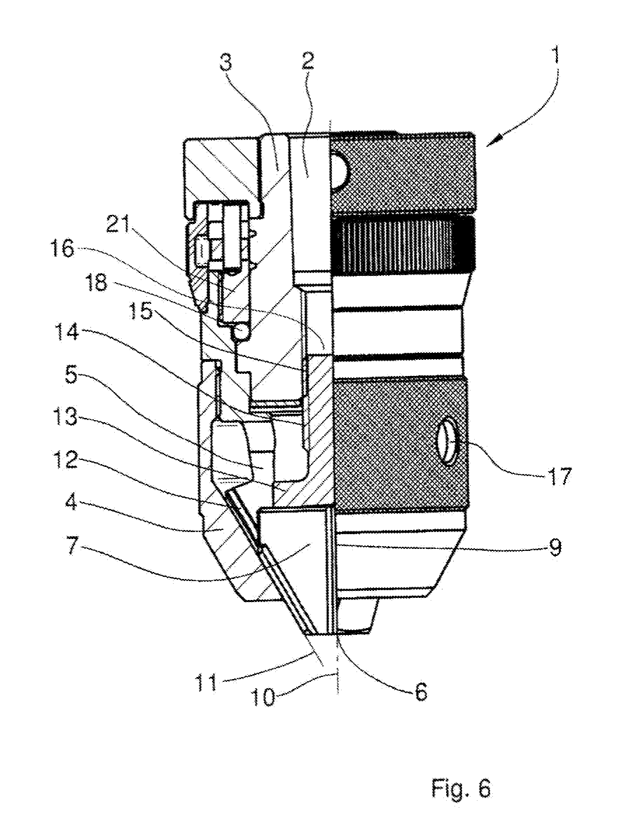

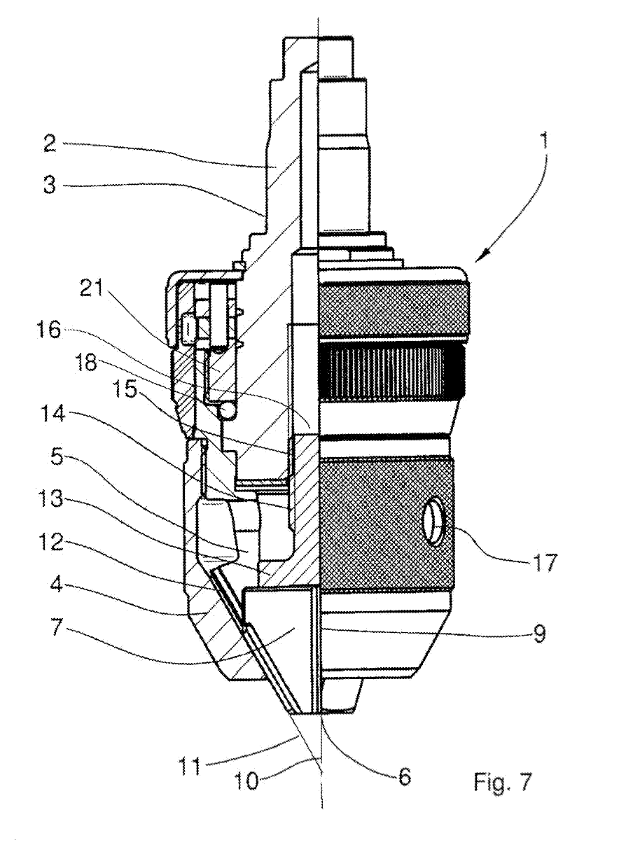

FIGS. 5 to 7 show a further embodiments of the drill chuck 1 according to the invention, whereby the ball bearing now is no longer located only between the jaw holder 5 and the chuck body 3, but an additional gripping ring 21 axially locks the rear end of the ball bearing 18. Thus, the balls are in a housing that is formed by the chuck body 3, the jaw holder 5 and the gripping ring 21. In the embodiment of drill chuck 1 according to FIG. 5, the spindle connection is also formed with an internal screwthread. FIG. 7 shows the corresponding embodiment of the drill chuck 1 according to FIG. 5 with a tool spindle that is formed integral with the chuck body 3.

I claim:

1. A chuck comprising:
a chuck body centered on and rotatable by a drive spindle about a body axis and having an axially forwardly open central threaded hole;
a tightening assembly rotatable about the axis on the chuck body and formed with a plurality of angularly spaced guides each having an inner guide face extending at an angle substantially greater than 20° to the body axis;
respective jaws shiftable along the guide faces between radial outer positions retracted axially rearwardly into the tightening assembly and radial inner positions projecting axially forwardly from the tightening assembly; and
a pusher angularly coupled to the jaws and to the tightening assembly and threaded into the hole of the body such that rotation of the assembly on the body in a tightening direction screws the pusher axially forwardly in the chuck body and shifts the jaws axially forward and radially inward on the respective guide faces and opposite rotation in a loosening direction shifts the jaws axially rearward and radially outward on the respective guide faces.

2. The chuck defined in claim 1, wherein the angle is between 20° and 50°.

3. The chuck defined in claim 1, wherein the angle is between 25° and 35°.

4. The chuck defined in claim 1, wherein the tightening assembly includes
a tubular tightening sleeve having at a front end of the chuck a frustoconical inner surface forming the faces, and
holder fixed to and rotatable with the sleeve and extending radially between the jaws.

5. The chuck defined in claim 4, wherein the sleeve is of increasing wall thickness at the frustoconical inner surface toward the front end.

6. The chuck defined in claim 4, wherein the jaws have outer edges riding on the respective guide faces and inner edges extending substantially parallel to the body axis.

7. The chuck defined in claim 1, wherein the connection is an axially centered and rearwardly open bore.

8. The chuck defined in claim 1, wherein the connection is an axially centered and rearwardly projections spindle unitarily formed with the chuck body.
